(19) United States
(12) Patent Application Publication
(10) Pub. No.: US 2008/0294518 A1
(43) Pub. Date: Nov. 27, 2008

(54) Method and apparatus for tracking parameters associated with a redemption certificate

(76) Inventors: Benjamin R. Weiss, Portola Valley, CA (US); Dale Knievel, San Jose, CA (US); Philip J. McKay, Monterey, CA (US)

Correspondence Address: PVF -- INTUIT, INC.;c/o PARK, VAUGHAN & FLEMING LLP, 2820 FIFTH STREET, DAVIS, CA, 95618-7759, US

(21) Appl. No.: 11/805,500

(22) Filed: May 22, 2007

(51) Int. Cl. G06Q 30/00

(52) U.S. Cl. 705/14

(57) ABSTRACT

A system that tracks parameters associated with a redemption certificate is presented. During operation, the system receives parameters associated with the redemption certificate. The system then determines whether the parameters indicate that a specified event has occurred. If so, the system performs a specified action for the specified event.

### BACKGROUND

### Related Art

The present invention relates to techniques for tracking parameters associated with a redemption certificate, such as a gift card, a gift certificate, or a coupon.

Finding a suitable gift for a friend is often a difficult and time-consuming task which involves accounting for the personal taste of the friend, and also knowing what the friend already has and what the friend needs. Retailers have responded to this problem by selling redemption certificates, such as gift cards and gift certificates, which can be used as if they were cash. Thus, a recipient of the redemption certificate can purchase a product or service that the recipient wants.

Unfortunately, these redemption certificates often include terms and conditions which restrict usage of the redemption certificate. For example, a gift card may expire one year from the date of purchase of the gift card, regardless of the remaining balance on the gift card. Similarly, the value of a gift card may decrease periodically after a certain time period has elapsed. For example, the value of the gift card may decrease by $2 each month following the third month from the date of purchase of the gift card. Gift givers and gift recipients are often unaware of such terms and conditions. Furthermore, a person may have multiple redemption certificates. Hence, keeping track of the terms and conditions of these multiple redemption certificates can be burdensome.

A similar problem arises with other types of redemption certificates, such as coupons. Coupons are typically issued by product manufacturers and retailers to encourage consumers to purchase their products. However, these coupons typically include expiration dates. As with a gift card or a gift certificate, a person may possess many coupons. Thus, keeping track of the expiration dates of these coupons can also be a problem.

### SUMMARY

One embodiment of the present invention provides a system that tracks parameters associated with a redemption certificate. During operation, the system receives parameters associated with the redemption certificate. The system then determines whether the parameters indicate that a specified event has occurred. If so, the system performs a specified action associated with the specified event.

In one embodiment, prior to receiving the parameters associated with the redemption certificate, the system determines the parameters associated with the redemption certificate.

In one embodiment, while determining the parameters, the system optically scans the redemption certificate to produce a digital image of the redemption certificate. The system then processes the digital image to extract the parameters for the redemption certificate.

In one embodiment, while determining the parameters, the system determines one or more identifiers associated with the redemption certificate. Next, the system identifies one or more data sources which include the parameters for the redemption certificate based on the one or more identifiers. The system then retrieves parameters associated with the redemption certificate from the one or more data sources based on the one or more identifiers.

In one embodiment, the one or more identifiers can include one or more of: a barcode; a name of an issuer of the redemption certificate; a postal address of the issuer; a phone number of the issuer; an email address of the issuer; and a universal resource locator (URL).

In one embodiment, while determining the one or more identifiers, the system optically scans the redemption certificate to produce a digital image of the redemption certificate. The system then processes the digital image to extract the one or more identifiers.

In one embodiment, while determining the one or more identifiers, the system scans a barcode located on the redemption certificate. The system then associates the barcode with an identifier.

In one embodiment, if the redemption certificate is an electronic redemption certificate, while determining the one or more identifiers, the system parses the electronic redemption certificate to extract the one or more identifiers.

In one embodiment, the one or more data sources can include: a database which includes parameters for one or more redemption certificates; and a website associated with an issuer of the redemption certificate.

In one embodiment, if a data source is the database, retrieving the parameters involves using a structured financial data protocol to retrieve the parameters from the database.

In one embodiment, the structured financial data protocol is an open financial exchange (OFX) protocol.

In one embodiment, if a data source is the website, retrieving the parameters involves performing a screen-scrape operation, which parses unstructured financial data received from the website to produce the parameters from the website.

In one embodiment, while receiving the parameters, the system receives the parameters from an end user.

In one embodiment, the specified action can include one or more of: generating a notification that the specified event has occurred; converting the redemption certificate to a newer version of the redemption certificate; converting the redemption certificate into cash; converting the redemption certificate into a cash-equivalent instrument; selling the redemption certificate; reporting a balance remaining on the redemption certificate; and reporting a time remaining before the redemption certificate expires.

In one embodiment, the notification can include: an electronic mail notification; a notification generated within a client-based financial application; a notification generated within a web-based financial application; an instant message; a short message service (SMS) message; and a telephone message.

In one embodiment, a user can configure a specified action to be performed when a specified event has occurred

In one embodiment, the specified event can include one or more of: a specified amount of time before an expiration date for the redemption certificate; a specified remaining balance on the redemption certificate; and a specified amount of time before a penalty fee is applied.

In one embodiment, the redemption certificate can include: a gift card; a gift certificate; and a coupon.

In one embodiment, the redemption certificate can include: a physical redemption certificate; and an electronic redemption certificate.

In one embodiment, the parameters can include one or more of: a value of the redemption certificate; an expiration date for the redemption certificate; a penalty fee for not using the redemption certificate within a specified time period; a time when a penalty fee is applied; an issuer of the redemption certificate; a remaining balance of the redemption certificate; a discount value; and other terms and conditions for the redemption certificate.

In one embodiment, the parameters for the redemption certificate can be located on one or more of: the redemption certificate; a document associated with the redemption certificate; a website associated with the redemption certificate; and a database which includes information about one or more redemption certificates.

In one embodiment, the method is performed by a web-based financial application.

In one embodiment, the method is performed by a client-based financial application.

In one embodiment, the method is performed by a financial application which can be used by one or more of: an end user; and an issuer of the redemption certificate.

### BRIEF DESCRIPTION OF THE FIGURES

FIG. 1 illustrates a computer system in accordance with an embodiment of the present invention.

FIG. 2 illustrates components for a financial application in accordance with an embodiment of the present invention.

FIG. 3 presents a flow chart illustrating a process of tracking parameters associated with a redemption certificate within a financial application in accordance with an embodiment of the present invention.

FIG. 4 presents a flow chart illustrating a process of determining parameters associated with a redemption certificate in accordance with an embodiment of the present invention.

FIG. 5 presents a flow chart illustrating another process of determining parameters associated with a redemption certificate in accordance with an embodiment of the present invention.

FIG. 6 presents a flow chart illustrating a process of determining one or more identifiers associated with a redemption certificate in accordance with an embodiment of the present invention.

FIG. 7 presents a flow chart illustrating another process of determining one or more identifiers associated with a redemption certificate in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer readable media now known or later developed.

### Overview

One embodiment of the present invention tracks parameters associated with a redemption certificate and performs a specified action when a specified event has occurred. For example, assume that a gift card expires after one year. In this case, the present invention can perform one or more specified actions before the gift card expires, such as generating a reminder within a financial application indicating that the gift card is about to expire. The process of tracking parameters associated with a redemption certificate is described in more detail below.

In one embodiment, the term “financial application” denotes a computing system implemented application, process, program, module, and/or method capable of collecting, and/or processing and/or maintaining all or part of the data as described herein. As an example, in one embodiment, a financial application can be, but is not limited to, any one or more of the following: a computing system implemented personal financial management system; a computing system implemented point-of-sale system; a computing system implemented personal asset management system; a computing system implemented business asset management system; a computing system implemented personal accounting system; a computing system implemented business accounting system; and/or any of the numerous data gathering applications now known and/or later developed. In one embodiment, the financial application is a component of, a module of, is related to, has access to, and/or is otherwise associated with, one or more other computing system implemented applications, programs, modules, and/or methods.

As used herein, the term “redemption certificate” denotes any mechanism whereby monetary value and/or property are provided to the user by virtue of the user being a holder of the redemption certificate. As an example, in one embodiment, the term redemption certificate includes, but is not limited to: a gift card; a gift certificate; a gift voucher; a customer reward card; a customer reward credit account; a coupon; a discount certificate and/or voucher; and/or any other mechanism for providing a holder of the redemption certificate with a value, a product, and/or a service.

As used herein, a redemption certificate can take any one of numerous forms including, but not limited to: printed form, such as a printed certificate, coupon, voucher, and/or receipt; card form, such as a gift card, dedicated credit card, discount card, voucher card, and/or rebate card; electronic form, such as data transferred to the user and/or any other party via e-mail, data transferred to the user and/or any other party on a computer program product, data transferred to the user and/or any other party via any data storage device; and/or any other now known and/or later developed, for conveying information and/or value to the user and/or any other party.

### Computer System

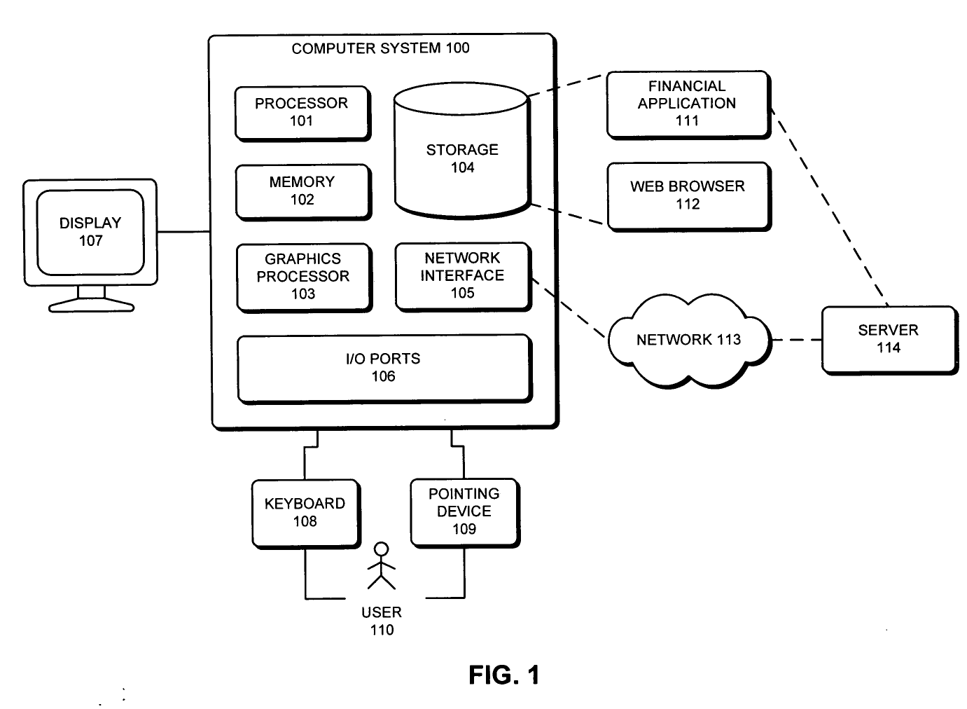

FIG. 1 illustrates a computer system 100 in accordance with an embodiment of the present invention. Computer system 100 includes, but is not limited to: processor 101, memory 102, graphics processor 103, storage device 104, network interface 105, and I/O ports 106. In one embodiment, computer system 100 is coupled to display 107, keyboard 108, and pointing device 109. In one embodiment, computer system 100 is coupled to one or more remote servers through network 113. For example, computer system 100 can be coupled to server 114 through network 113.

Processor 101 can generally include any type of processor, including, but not limited to, a microprocessor, a mainframe computer, a digital signal processor, a personal organizer, a device controller and a computational engine within an appliance. Memory 102 can include any type of memory, including but not limited to, dynamic random access memory (DRAM), static random access memory (SRAM), flash memory, read only memory (ROM), and any other type of memory now known or later developed. Graphics processor 103 can include a dedicated processor which performs graphics operations on pixels. For example, graphics processor 103 can include, but is not limited to, a graphics processing unit (GPU). Storage device 104 can include any type of non-volatile storage device that can be coupled to a computer system. This includes, but is not limited to, magnetic, optical, and magneto-optical storage devices, as well as storage devices based on flash memory and/or battery-backed up memory.

Network interface 105 can include any type of interface that provides connectivity between a computer system and a network, including, but not limited to: a wireless network interface, an Ethernet interface, and a phone network interface. I/O ports 106 can include one or more I/O ports, wherein each port can include, but is not limited to, a serial port, a parallel port, a PS/2 port, a Universal Serial Bus (USB) port, a video graphics array (VGA) port, a Digital Visual Interface (DVI) port, a mini-DVI port, a High-Definition Multimedia Interface (HDMI), a DisplayPort port, an Ethernet port, a modem port, or any other I/O port now known or later developed.

Display 107 can include any device which can display the user interface of computer system 100, including, but not limited to: a cathode ray tube (CRT) display, a liquid crystal display (LCD), a television display, a plasma display, and a projector. In one embodiment, display 107 can display video signals generated by graphics processor 103. In another embodiment, display 107 can display video signals generated by an external video source coupled to computer system 100. In another embodiment, display 107 can display video signals generated by an external video source coupled to display 107.

In one embodiment, a user 110 interacts with computer system 100 through keyboard 108, pointing device 109, and display 107. Keyboard 108 can include any device which facilitates entering characters of the alphabet and other text symbols to computer system 100. Pointing device 109 can include, but is not limited to, a mouse, a trackball, a stylus pen, and a touchpad.

In one embodiment, storage device 104 includes financial application 111, which can include, but is not limited to, an accounting application.

In one embodiment, storage device 104 includes web browser 112, which uses network interface 105 to interact with server 114 through network 113. Web browser 112 can include any network-enabled application which can interact with Internet applications through a network. For example, web browser 112 can include, but is not limited to: Microsoft® Internet Explorer®, Mozilla® Firefox®, Apple® Safari™, and a web browser embedded within another application such as financial application 111. (Note that Microsoft and Internet Explorer are either registered trademarks or trademarks of Microsoft Corporation in the United States and/or other countries. Mozilla and Firefox are registered trademarks of the Mozilla Foundation in the United States and/or other countries. Apple and Safari are either trademarks or registered trademarks of Apple Inc.) Network 113 can generally include any type of wired or wireless communication channel capable of coupling together computing nodes. This includes, but is not limited to, a local area network, a wide area network, or a combination of networks. In one embodiment of the present invention, network 113 includes the Internet. Server 114 can generally include any nodes on a computer network including a mechanism for servicing requests from a client for computational and/or data storage resources.

In one embodiment, financial application 111 is located on a storage device which is separate from computer system 100. For example, the storage device can be within another computer system (e.g., server 114), within a storage array network (SAN), or within a network file system (NFS). In this embodiment, the remote storage device is coupled to computer system 100 through network 113. Furthermore, the remote storage device can be mounted by computer system 100 as if the remote storage device is a local storage device. As a result, computer system 100 can execute financial application 111 as if it were stored on a local storage device.

In one embodiment, financial application 111 is a web-based application located on and executed by server 114. In this embodiment, user 110 accesses financial application 111 on server 114 using web browser 112.

### Tracking Parameters Associated With a Redemption Certificate

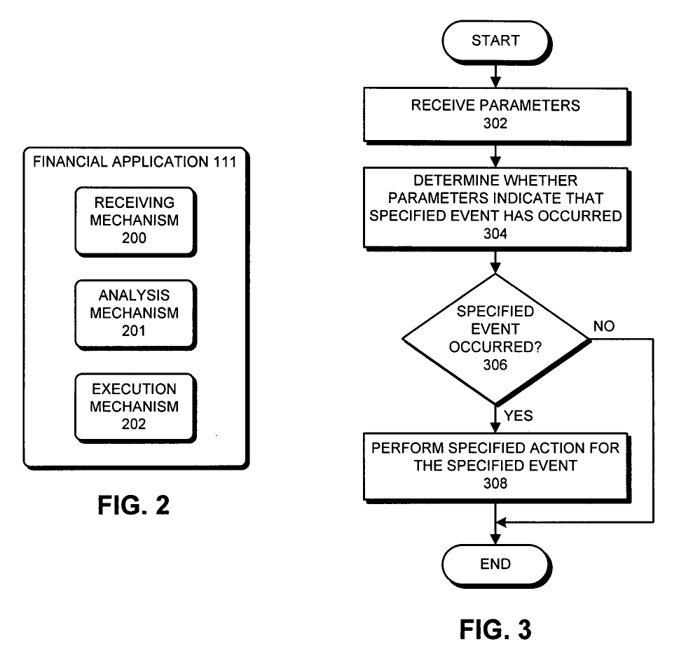

FIG. 2 illustrates components for financial application 111 in accordance with an embodiment of the present invention. In one embodiment, financial application 111 includes, but is not limited to, receiving mechanism 200, analysis mechanism 201, and execution mechanism 202. In one embodiment, receiving mechanism 200 is configured to receive parameters associated with the redemption certificate. In one embodiment, analysis mechanism 201 is configured to determine whether the parameters indicate that a specified event has occurred. In one embodiment, if analysis mechanism 201 determines that a specified event has occurred, execution mechanism 202 is configured to perform a specified action for the specified event. These mechanisms are described in more detail with reference to FIGS. 3-7 below.

In one embodiment, the redemption certificate can include, but is not limited to: a gift card; a gift certificate; and a coupon. Moreover, the redemption certificate can include a physical redemption certificate or an electronic redemption certificate. Note that the redemption certificate can also be any combination of the above. For example, the redemption certificate can be an electronic gift card. Similarly, the redemption certification can be a physical coupon (e.g., a paper coupon).

In one embodiment, the parameters can include, but are not limited to, one or more of: a value of the redemption certificate (e.g., dollar value of a gift card); an expiration date for the redemption certificate; a penalty fee for not using the redemption certificate within a specified time period; a time when a penalty fee is applied; an issuer of the redemption certificate (e.g., a manufacturer or a retailer); a remaining balance of the redemption certificate; a discount value (e.g., a discount value for a particular product); and other terms and conditions for the redemption certificate.

In one embodiment, the parameters for the redemption certificate can be located on one or more of: the redemption certificate; a document associated with the redemption certificate; a website associated with the redemption certificate; and a database which includes information about one or more redemption certificates.

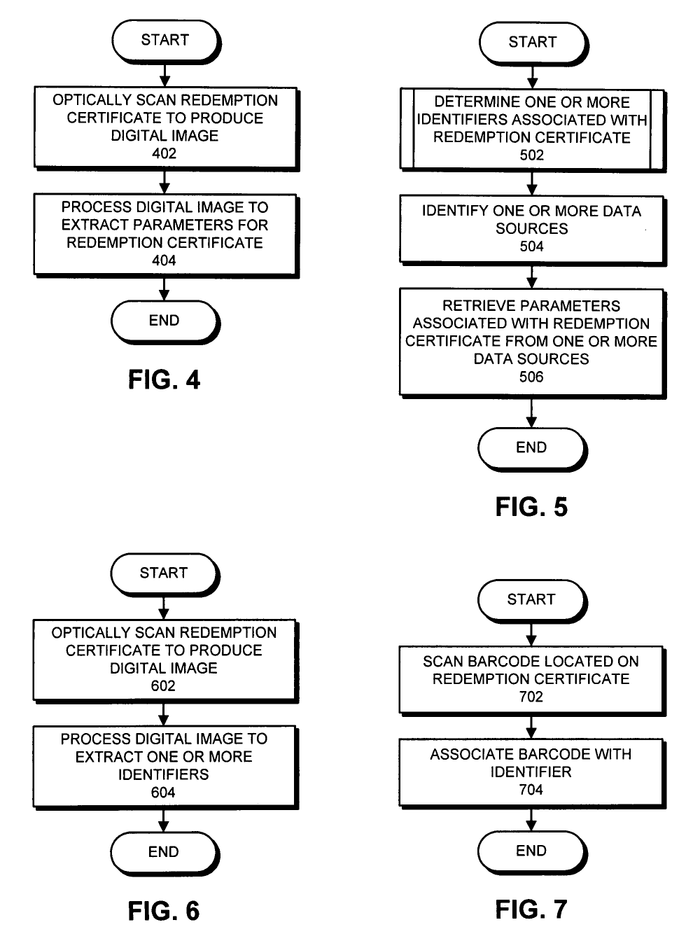

FIG. 3 presents a flow chart illustrating a process of tracking parameters associated with a redemption certificate within a financial application in accordance with an embodiment of the present invention. The process begins when the system receives parameters associated with the redemption certificate (step 302). In one embodiment, prior to receiving the parameters associated with the redemption certificate, the system determines the parameters associated with the redemption certificate. This embodiment is described in more detail with reference to FIGS. 4-5. In another embodiment, the system receives the parameters from an end user. For example, the end user can manually enter the parameters into the financial application.

Returning to FIG. 3, the system then determines whether the parameters indicate that a specified event has occurred (step 304). In one embodiment, the specified event can include, but is not limited to, one or more of: a specified amount of time before an expiration date for the redemption certificate (e.g., six months before the redemption certificate expires); a specified remaining balance on the redemption certificate; and a specified amount of time before a penalty fee is applied (e.g., a $2/month penalty fee applies two months after the date of purchase of the redemption certificate).

If the system determines that a specified event has occurred (step 306, yes), the system performs a specified action for the specified event (step 308). In one embodiment, the specified action can include, but is not limited to, one or more of: generating a notification that the specified event has occurred; converting the redemption certificate to a newer version of the redemption certificate (e.g., using a soon-to-expire gift card to purchase a new gift card from the same issuer); converting the redemption certificate into cash; converting the redemption certificate into a cash-equivalent instrument (e.g., using a gift card to purchase a calling card which does not expire); selling the redemption certificate (e.g., placing the card on an online auction website); reporting a balance remaining on the redemption certificate; and reporting a time remaining before the redemption certificate expires. In one embodiment, the specified action is performed automatically by the financial application.

In one embodiment, the notification can include, but is not limited to: an electronic mail notification; a notification generated within a client-based financial application; a notification generated within a web-based financial application; an instant message; a short message service (SMS) message; and a telephone message.

In one embodiment, a user can configure a specified action to be performed when a specified event has occurred.

In one embodiment, the financial application can be used by one or more of: an end user; and an issuer of the redemption certificate.

### Determining Parameters for a Redemption Certificate

FIG. 4 presents a flow chart illustrating a process of determining parameters associated with a redemption certificate in accordance with an embodiment of the present invention. The process begins when the system optically scans the redemption certificate to produce a digital image of the redemption certificate (step 402). For example, user 110 can insert the redemption certificate into a digital scanner to produce a digital image of the redemption certificate. Note that the digital scanner can include, but is not limited to: a flatbed scanner; a document scanner; and a hand-operated scanner.

The system then processes the digital image to extract the parameters for the redemption certificate (step 404). For example, the system can perform an optical character recognition (OCR) operation on the digital image to recognize and extract text from the digital image. The system can then parse the extracted text to determine the parameters.

FIG. 5 presents a flow chart illustrating another process of determining parameters associated with a redemption certificate in accordance with an embodiment of the present invention. The process begins when the system determines one or more identifiers associated with the redemption certificate (step 502). Note that step 502 is described in more detail with reference to FIGS. 6-7. In one embodiment, the one or more identifiers can include, but are not limited to, one or more of: a barcode; a name of an issuer of the redemption certificate; a postal address of the issuer; a phone number of the issuer; an email address of the issuer; and a universal resource locator (URL).

The system also identifies one or more data sources which include the parameters for the redemption certificate based on the one or more identifiers (step 504). In one embodiment, the system can select a data source based on an identifier for the issuer of the redemption certificate. For example, if the URL for the issuer of the redemption certificate is included on the redemption certificate, the system uses the URL for the issuer of the redemption certificate as a data source. The system can also use a predetermined central database as a data source. Hence, in one embodiment, the one or more data sources can include, but are not limited to: a database which includes parameters for one or more redemption certificates; and a website associated with an issuer of the redemption certificate.

The system then retrieves parameters associated with the redemption certificate from the one or more data sources based on the one or more identifiers (step 506).

In one embodiment, if a data source is a database, the system retrieves the parameters from the database using a structured financial data protocol. In one embodiment, the structured financial data protocol is an open financial exchange (OFX) protocol.

In another embodiment, if a data source is the website, the system retrieves the parameters from the website by performing a screen-scrape operation, which parses unstructured financial data received from the website.

FIG. 6 presents a flow chart illustrating a process of determining one or more identifiers associated with a redemption certificate in accordance with an embodiment of the present invention. The process begins when the system optically scans the redemption certificate to produce a digital image of the redemption certificate (step 602). Note that the digital image can be produced using a digital scanner as described above with reference to step 402 in FIG. 4. The system then processes the digital image to extract the one or more identifiers (step 604). The process of extracting data from a digital image is described above with reference to step 404 in FIG. 4.

FIG. 7 presents a flow chart illustrating another process of determining one or more identifiers associated with a redemption certificate in accordance with an embodiment of the present invention. The process begins when the system scans a barcode located on the redemption certificate (step 702). Note that the barcode can be scanned using a barcode scanner. The system then associates the barcode with an identifier (step 704). In one embodiment, associating the barcode with an identifier can involve first translating the barcode into an alphanumeric sequence and then looking up the alphanumeric sequence in a database to determine one or more identifiers associated with the redemption certificate.

In one embodiment, if the redemption certificate is an electronic redemption certificate, the system determines the one or more identifiers by parsing the electronic redemption certificate to extract the one or more identifiers.

The examples described below illustrate several exemplary situations in which the present invention can be applied to determine parameters for a redemption certificate. These examples are not meant to limit the scope of the present invention.

In one example, a user reads the terms and conditions contained in the redemption certificate, a website for the redemption certificate, or a document included with a redemption certificate. The user then enters these terms and conditions into a financial application.

In another example, the redemption certificate includes the terms and conditions on the redemption certificate itself. In this example, a user scans the redemption certificate using a digital scanner to produce a digital image of the redemption certificate. The digital image is then imported into the financial application, which processes the digital image to extract the terms and conditions for the redemption certificate. Note that another application can process the digital image and generate text which is imported into the financial application. In this case, the financial application parses the text to determine the terms and conditions for the redemption certificate.

In another example, a user scans a barcode located on a redemption certificate using a barcode scanner. The data from the barcode scanner is then imported into a financial application. The financial application then translates the scanned barcode into an alphanumeric sequence and uses the alphanumeric sequence to identify a data source which contains the terms and conditions for the redemption certificate. Note that if the barcode scanner translates the scanned barcode into an alphanumeric sequence, the financial application does not need to perform the translation operation. The financial application then retrieves the terms and conditions from the identified data source. For example, the financial application can access a website which includes the terms and conditions for the redemption certificate and can perform a screen-scrape operation to retrieve the terms and conditions from the website. Similarly, the financial application can download the terms and conditions using the OFX protocol.

In another example, the redemption certificate does not include the terms and conditions on the redemption certificate. In this example, a user digitally scans a redemption certificate to produce a digital image of the redemption certificate. The digital image of the redemption certificate is then imported into the financial application. The financial application then processes the digital image to extract identifiers for the redemption certificate. (Note that another application can process the digital image and generate text which is imported into the financial application. In this case, the financial application parses the text to extract identifiers for the redemption certificate.) For example, if the redemption certificate includes a URL identifying a website where the terms and conditions are located, the financial application retrieves the terms and conditions from the website. Similarly, if the redemption certificate includes an address for the issuer of the redemption certificate, the financial application can use the address to retrieve the terms and conditions from a data source which includes the terms and conditions for a number of redemption certificates. Alternatively, the financial application can use the address to identify a data source which contains the terms and conditions for the redemption certificate. The financial application then retrieves the terms and conditions from the identified data source.

In another example, the redemption certificate is an electronic redemption certificate. In this example, the financial application imports and parses the electronic redemption certificate to identify one or more data sources which contain the terms and conditions for the redemption certificate. The financial application then retrieves the terms and conditions from the data source.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for tracking parameters associated with a redemption certificate, comprising:
receiving parameters associated with the redemption certificate;
determining whether the parameters indicate that a specified event has occurred; and
if so, performing a specified action for the specified event.

2. The method of claim 1, wherein prior to receiving the parameters associated with the redemption certificate, the method further comprises determining the parameters associated with the redemption certificate.

3. The method of claim 2, wherein determining the parameters involves:
optically scanning the redemption certificate to produce a digital image of the redemption certificate; and
processing the digital image to extract the parameters for the redemption certificate.

4. The method of claim 2, wherein determining the parameters involves:
determining one or more identifiers associated with the redemption certificate;
identifying one or more data sources which include the parameters for the redemption certificate based on the one or more identifiers; and retrieving parameters associated with the redemption certificate from the one or more data sources based on the one or more identifiers.

5. The method of claim 4, wherein the one or more identifiers can include one or more of:
a barcode;
a name of an issuer of the redemption certificate;
a postal address of the issuer;
a phone number of the issuer;
an email address of the issuer; and
a universal resource locator (URL).

6. The method of claim 4, wherein determining the one or more identifiers involves:
optically scanning the redemption certificate to produce a digital image of the redemption certificate; and
processing the digital image to extract the one or more identifiers.

7. The method of claim 4, wherein determining the one or more identifiers involves:
scanning a barcode located on the redemption certificate; and
associating the barcode with an identifier.

8. The method of claim 4, wherein if the redemption certificate is an electronic redemption certificate, determining the one or more identifiers involves parsing the electronic redemption certificate to extract the one or more identifiers.

9. The method of claim 4, wherein the one or more data sources can include:
a database which includes parameters for one or more redemption certificates; and
a website associated with an issuer of the redemption certificate.

10. The method of claim 9, wherein if a data source is the database, retrieving the parameters involves using a structured financial data protocol to retrieve the parameters from the database.

11. The method of claim 10, wherein the structured financial data protocol is an open financial exchange (OFX) protocol.

12. The method of claim 9, wherein if a data source is the website, retrieving the parameters involves performing a screen-scrape operation, which parses unstructured financial data received from the website to produce the parameters from the website.

13. The method of claim 1, wherein receiving the parameters involves receiving the parameters from an end user.

14. The method of claim 1, wherein the specified action can include one or more of:
generating a notification that the specified event has occurred;
converting the redemption certificate to a newer version of the redemption certificate;
converting the redemption certificate into cash;
converting the redemption certificate into a cash-equivalent instrument;
selling the redemption certificate;
reporting a balance remaining on the redemption certificate; and
reporting a time remaining before the redemption certificate expires.

15. The method of claim 14, wherein the notification can include:
an electronic mail notification;
a notification generated within a client-based financial application;
a notification generated within a web-based financial application;
an instant message;
a short message service (SMS) message; and
a telephone message.

16. The method of claim 14, wherein a user can configure a specified action to be performed when a specified event has occurred.

17. The method of claim 1, wherein the specified event can include one or more of:
a specified amount of time before an expiration date for the redemption certificate;
a specified remaining balance on the redemption certificate; and
a specified amount of time before a penalty fee is applied.

18. The method of claim 1, wherein the redemption certificate can include:
a gift card;
a gift certificate; and
a coupon.

19. The method of claim 1, wherein the redemption certificate can include:
a physical redemption certificate; and
an electronic redemption certificate.

20. The method of claim 1, wherein the parameters can include one or more of:
a value of the redemption certificate;
an expiration date for the redemption certificate;
a penalty fee for not using the redemption certificate within a specified time period;
a time when a penalty fee is applied;
an issuer of the redemption certificate;
a remaining balance of the redemption certificate;
a discount value; and
other terms and conditions for the redemption certificate.

21. The method of claim 1, wherein the parameters for the redemption certificate can be located on one or more of:
the redemption certificate;
a document associated with the redemption certificate;
a website associated with the redemption certificate; and
a database which includes information about one or more redemption certificates.

22. The method of claim 1, wherein the method is performed by a web-based financial application.

23. The method of claim 1, wherein method is performed by a client-based financial application.

24. The method of claim 1, wherein the method is performed by a financial application which can be used by one or more of:
an end user; and
an issuer of the redemption certificate.

25. A computer-readable storage medium storing instructions that when executed by a computer cause the computer to perform a method for tracking parameters associated with a redemption certificate, wherein the method comprises:
receiving parameters associated with the redemption certificate;
determining whether the parameters indicate that a specified event has occurred; and
if so, performing a specified action for the specified event.

26. The computer-readable storage medium of claim 25, wherein prior to receiving the parameters associated with the redemption certificate, the method further comprises determining the parameters associated with the redemption certificate.

27. The computer-readable storage medium of claim 26, wherein determining the parameters involves:
optically scanning the redemption certificate to produce a digital image of the redemption certificate; and
processing the digital image to extract the parameters for the redemption certificate.

28. The computer-readable storage medium of claim 26, wherein determining the parameters involves:
determining one or more identifiers associated with the redemption certificate;
identifying one or more data sources which include the parameters for the redemption certificate based on the one or more identifiers; and
retrieving parameters associated with the redemption certificate from the one or more data sources based on the one or more identifiers.

29. The computer-readable storage medium of claim 28, wherein the one or more identifiers can include one or more of:
a barcode;
a name of an issuer of the redemption certificate;
a postal address of the issuer;
a phone number of the issuer;
an email address of the issuer; and
a universal resource locator (URL).

30. The computer-readable storage medium of claim 28, wherein determining the one or more identifiers involves:
optically scanning the redemption certificate to produce a digital image of the redemption certificate; and
processing the digital image to extract the one or more identifiers.

31. The computer-readable storage medium of claim 28, wherein determining the one or more identifiers involves:
scanning a barcode located on the redemption certificate; and
associating the barcode with an identifier.

32. The computer-readable storage medium of claim 28, wherein if the redemption certificate is an electronic redemption certificate, determining the one or more identifiers involves parsing the electronic redemption certificate to extract the one or more identifiers.

33. The computer-readable storage medium of claim 28, wherein the one or more data sources can include:
a database which includes parameters for one or more redemption certificates; and
a website associated with an issuer of the redemption certificate.

34. The computer-readable storage medium of claim 33, wherein if a data source is the database, retrieving the parameters involves using a structured financial data protocol to retrieve the parameters from the database.

35. The computer-readable storage medium of claim 34, wherein the structured financial data protocol is an open financial exchange (OFX) protocol.

36. The computer-readable storage medium of claim 33, wherein if a data source is the website, retrieving the parameters involves performing a screen-scrape operation, which parses unstructured financial data received from the website to produce the parameters from the website.

37. The computer-readable storage medium of claim 25, wherein receiving the parameters involves receiving the parameters from an end user.

38. The computer-readable storage medium of claim 25, wherein the specified action can include one or more of:
generating a notification that the specified event has occurred;
converting the redemption certificate to a newer version of the redemption certificate;
converting the redemption certificate into cash;
converting the redemption certificate into a cash-equivalent instrument;
selling the redemption certificate;
reporting a balance remaining on the redemption certificate; and
reporting a time remaining before the redemption certificate expires.

39. The computer-readable storage medium of claim 38, wherein the notification can include:
an electronic mail notification;
a notification generated within a client-based financial application;
a notification generated within a web-based financial application;
an instant message;
a short message service (SMS) message; and
a telephone message.

40. The computer-readable storage medium of claim 38, wherein a user can configure a specified action to be performed when a specified event has occurred.

41. The computer-readable storage medium of claim 25, wherein the specified event can include one or more of:
a specified amount of time before an expiration date for the redemption certificate;
a specified remaining balance on the redemption certificate; and
a specified amount of time before a penalty fee is applied.

42. The computer-readable storage medium of claim 25, wherein the redemption certificate can include:
a gift card;
a gift certificate; and
a coupon.

43. The computer-readable storage medium of claim 25, wherein the redemption certificate can include:
a physical redemption certificate; and
an electronic redemption certificate.

44. The computer-readable storage medium of claim 25, wherein the parameters can include one or more of:
a value of the redemption certificate;
an expiration date for the redemption certificate;
a penalty fee for not using the redemption certificate within a specified time period;
a time when a penalty fee is applied;
an issuer of the redemption certificate;
a remaining balance of the redemption certificate;
a discount value; and
other terms and conditions for the redemption certificate.

45. The computer-readable storage medium of claim 25, wherein the parameters for the redemption certificate can be located on one or more of:
the redemption certificate;
a document associated with the redemption certificate;
a website associated with the redemption certificate; and
a database which includes information about one or more redemption certificates.

46. The computer-readable storage medium of claim 25, wherein the method is performed by a web-based financial application.

47. The computer-readable storage medium of claim 25, wherein the method is performed by a client-based financial application.

48. The computer-readable storage medium of claim 25, wherein the method is performed by a financial application which can be used by one or more of:
an end user; and
an issuer of the redemption certificate.

49. An apparatus that tracks parameters associated with a redemption certificate, comprising:
a receiving mechanism configured to receive parameters associated with the redemption certificate;
an analysis mechanism configured to determine whether the parameters indicate that a specified event has occurred; and
an execution mechanism, wherein if the analysis mechanism determines that the parameters indicate that a specified event has occurred, the execution mechanism is configured to perform a specified action for the specified event.
